(19) United States
(12) Patent Application Publication
(10) Pub. No.: US 2010/0215905 A1
(43) Pub. Date: Aug. 26, 2010

(54) Cleanroom wiper

(76) Inventor: Tian-Fa Liou, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,306

(22) Filed: Jul. 8, 2009

(30) Foreign Application Priority Data
Feb. 26, 2009 (TW) 098202884

(51) Int. Cl. B32B 3/30

(52) U.S. Cl. 428/156; 156/73.3

(57) ABSTRACT

A cleanroom wiper is revealed. A cleanroom wiper roll is embossed, melt and slit into a plurality of edge embossed-and-sealed rolls simultaneously by heat energy generated from ultrasonic vibration. Each of two sides in the warp direction of the edge embossed-and-sealed roll is formed with an embossed portion during the process of embossing and slitting in the warp direction. Thus the cloth fiber of the edge embossed-and-sealed roll is cut completely. Once again the edge embossed-and-sealed roll is embossed, melt and cut into small pieces of cleanroom wipers by heat energy of ultrasonic vibration. Each of four sides of the cleanroom wiper has an embossed portion so as to achieve the purposes of no frayed edges and low particle generation. Thus quality of high-tech products is improved effectively and the manufacturing cost is reduced. Therefore, the international competitiveness of high-tech industries is enhanced.

### BACKGROUND OF THE INVENTION

1. Fields of the Invention

The present invention relates to a cleanroom wiper, especially to a cleanroom wiper in which embossed sealing and slitting processes are finished together with slitting in the warp direction.

2. Descriptions of Related Art

A clean room is an enclosed space that has a controlled level of particles in the air. Generally, some environmental factors such as temperature, moisture, gas flow mode, vibration and noise, etc. Although cleanroom is seldom heard by people, it is essential equipment used in fields of semiconductor industry, medicine, biochemistry, food products, and so on. Along with advanced development of living standard and educational level, besides industries, cleanrooms are also applied to operation rooms of hospitals, intensive care units, burn ward, baby room and sterile (aseptic) requirement for food processing industry are wider and more varied for protection of our health.

While cleaning the cleanrooms, cleanroom wipers are used. The cleanroom wipers are essentials in cleanrooms of high-tech industries such as semiconductor industry, optoelectronic industry and electric industry and so on. The wipers features on super-cleanliness, dust removal, no frayed edges, no particle generation and superior softness without scratches on object surfaces. A cloth is set onto a slitting machine and a roll of cloth is cut into several rolls in small size in the slitting machine by laser or electric heat. Yet the temperature of the slitting machine is only 400 Celsius degrees. Thus when the slitting machine is applied to edge sealing, the width of one cut edge is 0.05 centimeters (cm) or the edge is cut to have two embossed sealing paths. The cloth fiber is not cut and sealed effectively for edge sealing and no particles. Moreover, after being washed by professional washers, the wiper is easy to become unraveled or frayed. Moreover, the lint-free cloth can be sealed in the warp direction and in the weft direction while the sealing in the warp direction is more difficult than that in the other direction. Thus the wiper is sealed by single blade edge cutting or embossed cut-out in the weft direction. The cleanliness of the cleanroom wiper is limited, unable to satisfy the requirements of high-tech products. Therefore, most of cleanroom wipers come from imported goods.

However, above cleanroom wipers have the following advantages in use:
1. Although edges of the above cleanroom wiper have been processed, cut and sealed, the width of the single sealed edge is only 0.05 cm or the each edge being cut horizontally has only two embossed sealing paths. The cloth fiber is not cut and sealed effectively for edge sealing and no fiber release. Moreover, after being washed by professional washers, the wiper is easily to have frayed edges and particle generation.
2. The wiper can only be cut and sealed by single blade edge cutting in the weft direction or embossed cutting in the weft direction. The quality of the products of wipers is unable to further improve and the high quality requirement of high-tech products is unable to achieve. Thus the competitiveness of the wiper products is reduced.

### SUMMARY OF THE INVENTION

Therefore it is a primary object of the present invention to provide a cleanroom wiper in which the wiper is slit, embossed and sealed simultaneously during slitting in the warp direction. Next the wiper can be sealed by single blade edge cutting or embossed cut-out in the weft direction according to product requirements. Moreover, the width of the embossed sealed edge can also be adjusted according to product requirements so as to improve quality and cleanliness of cleanroom wipers and roller wipers effectively.

In order to achieve above object, a cleanroom wiper roll is set into an ultrasonic embossed warp-type slitting machine. By the heat energy (the temperature is as high as 1000 degrees Celsius) generated from ultrasound with a frequency of 20000 vibrations per second, warp edges of the cleanroom wiper roll are embossed, melt and slit simultaneously into a plurality of edge embossed-and-sealed rolls. Each of two sides of the edge embossed-and-sealed roll in the warp direction is formed with an embossed portion during the process of embossing and slitting in the warp direction. Thus the cloth fiber of the edge embossed-and-sealed roll is cut completely. Next the edge embossed-and-sealed roll already being embossed, sealed and slit in the warp direction is set in an ultrasonic cross cut machine. Then once again by heat energy generated from ultrasound vibration, weft edges of the edge embossed-and-sealed roll are embossed, melt and cut into small pieces of cleanroom wipers whose four sides respectively are formed with an embossed portion. Thus the cleanroom wiper is without frayed edges and low particle generation.

In another embodiment of the present invention, the cleanroom wiper has an embossed portion formed in each of two sides in the weft direction or in the warp direction.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a cleanroom wiper roll according to the present invention;

FIG. 2 is a perspective view of an edge embossed-and-sealed roll according to the present invention;

FIG. 3 is an embodiment of a cleanroom wiper according to the present invention;

FIG. 4 is another embodiment of a cleanroom wiper according to the present invention;

FIG. 5 is a further embodiment of a cleanroom wiper according to the present invention;

FIG. 6 is a further embodiment of a cleanroom wiper according to the present invention.

### DETAILED DESCRIPTION OF THE PREFERRED EMBODIMENT

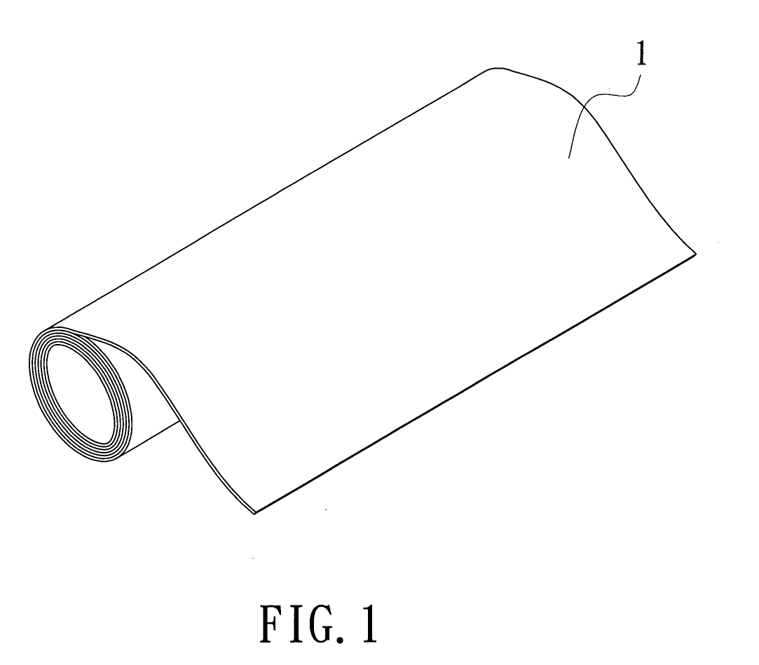

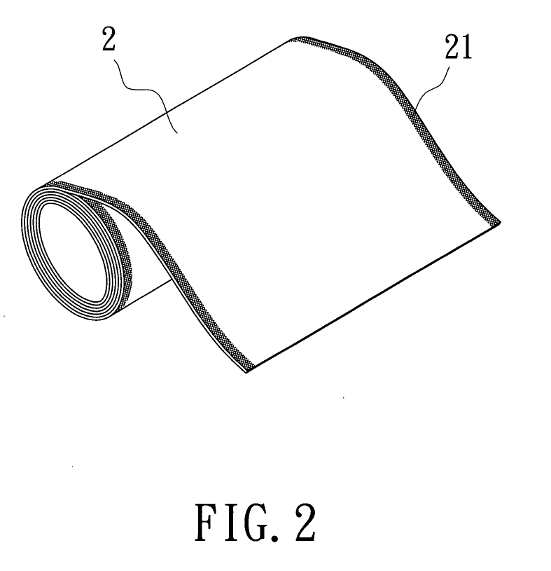

Refer to FIG. 1 and FIG. 2, a cleanroom wiper roll (1) of the present invention is set into an ultrasonic embossed warp-type slitting machine. By the heat energy (the temperature is as high as 1000 degrees Celsius) generated from ultrasound with a frequency of 20000 vibrations per second, warp edges of the cleanroom wiper roll (1) are embossed, melt and cut simultaneously to be slit into a plurality of edge embossed-and-sealed rolls (2). During the process of embossing and slitting in the warp direction, the warp edges on two sides of the edge embossed-and-sealed roll (2) are respectively formed an embossed portion (21) that cuts the cloth fiber of the edge embossed-and-sealed roll (2) completely. Moreover, after being washed by professional washers, the wiper will not only have no frayed edges and hooked yarns, but also achieve low particles and low ions. Thus the scratches on surfaces of the objects during wiping can be avoided. Furthermore, during the process of embossing and slitting in the warp direction, only slitting in the warp direction is taken and the embossing process is left out according to product requirements. As to the cleanroom wiper roll (1), there is no limits on the materials, size and width. The material can be long fiber or microfiber. The width of the roll ranges from 1 to 38 cm.

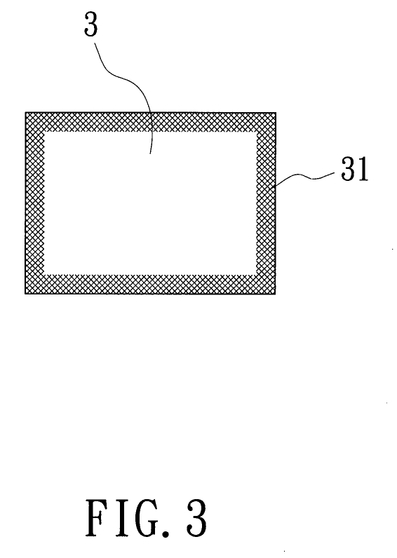

If all the four edges need to be embossed, refer to FIG. 2 and FIG. 3, the edge embossed-and-sealed roll (2) already being embossed, sealed and slit in the warp direction is set in an ultrasonic cross cut machine. Then by heat energy generated from ultrasound vibration, weft edges of the edge embossed-and-sealed roll (2) are embossed, melt and cut into small pieces of cleanroom wipers (3) whose four sides respectively are formed with an embossed portion (31). Thus the purposes of no frayed edges and no particle generation are achieved. While being applied to high-tech products and high precision products, there is no scratch and residue on product surfaces and the products are with high cleanliness. Thus quality of high-tech products is improved effectively and the manufacturing cost is reduced. And the international competitiveness of high-tech industries is enhanced.

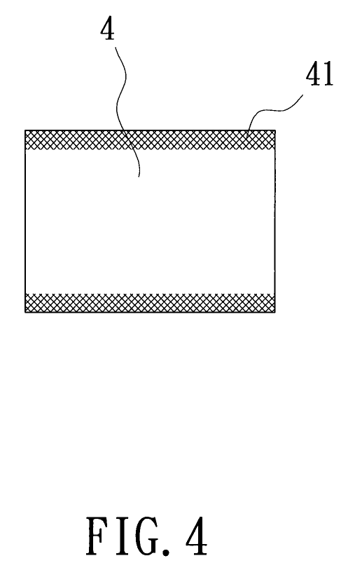

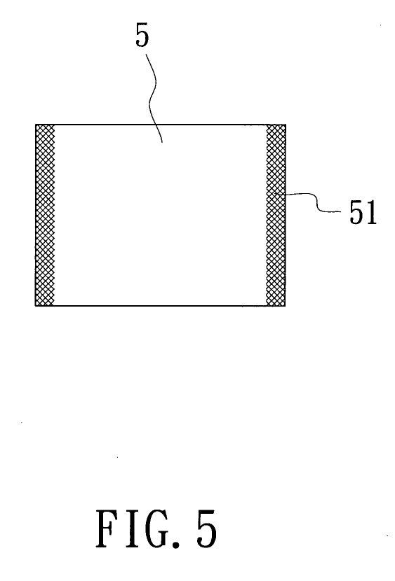

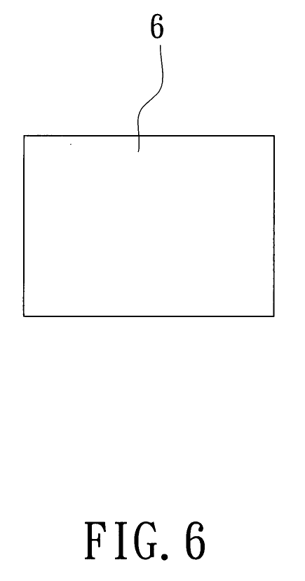

Refer to FIG. 4, another embodiment of cleanroom wipers is revealed. The difference between this embodiment and the one in FIG. 3 is in that the cleanroom wiper (4) is only slit in the warp direction without being embossed during processes of embossing and slitting in the warp direction in the ultrasonic embossed warp-type slitting machine. Then weft embossed and melt processes are done by the ultrasonic cross cut machine. Thus only each of two sides of the cleanroom wiper (4) in the weft direction has an embossed portion (41). Refer to FIG. 5, a further embodiment is disclosed. After being embossed and slit in the warp direction in the ultrasonic embossed warp-type slitting machine, the cleanroom wiper (5) is melt in the weft direction by the ultrasonic cross cut machine so that each of two sides in the warp direction of the cleanroom wiper (5) has an embossed portion (51). Refer to FIG. 6, a further embodiment is revealed. During the processes of embossing and slitting in the warp direction as well as the processes of embossing and melt in the weft direction, the cleanroom wiper (6) is not embossed. According to various requirements of the products, edges of the cleanroom wiper (6) are sealed by single blade edge cutting or embossed cut-out in the weft direction. Moreover, the width of the embossed sealed edge can be adjusted according to product requirements.

Compared with the technique available now, the present invention has the following advantages:
1. During processes of slitting in the warp direction, the present invention finishes embossed sealing and slitting simultaneously. Next edges of the wiper can be sealed by the single blade edge cutting or embossed cut-out in the weft direction according to requirements of the products. And the width of the embossed sealed edge can also be adjusted according to product requirements. Thus both quality and cleanliness of cleanroom wipers and roller wipers are improved effectively.
2. No matter edges of the surface of the wiper is sealed in the weft direction or in the warp direction, the wiper is with features of no frayed edges, no hooked yarns, low particles and low ions after being cleaned by professional washers. In use, the wiper will not scratch surfaces of the object. Thus the quality of the high-tech products is improved effectively and the manufacturing cost is reduced. Therefore, the international competitiveness of high-tech industries is enhanced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A cleanroom wiper comprising: an embossed portion in a warp direction on a cleanroom wiper roll formed by heat energy of ultrasonic vibration; wherein the cleanroom wiper roll is slit by the embossed portion to form a plurality of edge embossed-and-sealed rolls.

2. The cleanroom wiper as claimed in claim 1, wherein the edge embossed-and-sealed roll is cut into pieces of cleanroom wipers.

3. The cleanroom wiper as claimed in claim 2, wherein the cleanroom wiper is with the embossed portion in the weft direction.
